(19) United States
(12) Patent Application Publication
(10) Pub. No.: US 2013/0137449 A1
(43) Pub. Date: May 30, 2013

(54) Method of recording proof of driving speeds and related mobile device

(71) Applicant: Juhang Kuo, Tao-Yuan Hsien (TW)

(72) Inventor: Juhang Kuo, Tao-Yuan Hsien (TW)

(21) Appl. No.: 13/305,675

(22) Filed: Nov. 28, 2011

(51) Int. Cl. H04W 4/02

(52) U.S. Cl. 455/456.1

(57) ABSTRACT

A method of recording proof of driving speeds with a mobile device includes receiving position signals indicating a current position of the mobile device, calculating a driving speed at which the mobile device is moving, and searching a speed camera database and determining when the current position of the mobile device is within a threshold distance of a speed camera listed in the speed camera database. When the current position of the mobile device is within the threshold distance of the speed camera, a plurality of consecutive pictures are taken using a camera of the mobile device, each picture showing a time stamp indicating the current time, a geographical tag indicating the current position of the mobile device, and a speed stamp indicating the driving speed at which the mobile device is moving. The pictures are then stored in a storage device.

### BACKGROUND OF THE INVENTION

1. Field of the Invention

The invention relates to calculating a driving speed of a vehicle using received position signals, and more particularly, to a method of providing proof of driving speeds by taking photographs indicating proof of driving speeds calculated using received position signals such as Global Positioning System (GPS) signals.

2. Description of the Prior Art

Speed cameras are increasing in popularity as an easy and effective way for governments to catch speeding drivers driving faster than the speed limit. Once a picture is taken of the speeding driver with a speed camera, a ticket is printed out, usually containing a copy of the picture taken by the speed camera, and the ticket is mailed to the driver. Speed cameras combine a camera with some sort of speed detection technology, such as radar detection or laser detection. Once the speed detection technology notices that the driver is speeding, a picture is taken of the offending vehicle. The picture is often accompanied by identifying information of the vehicle as well as the driving speed at which the vehicle was moving.

However, in practice some speed cameras may not be calibrated correctly, and may take pictures of the wrong vehicle. The speed cameras may also take pictures of the correct vehicle, but the driving speed calculated by the speed detection technology may be incorrect. That is, due to either a timing problem as to when the picture is taken or due to incorrect speed detection settings, drivers may be falsely accused of speeding when they are in fact innocent. Therefore, there exists a need for drivers to be able to defend themselves by proving their innocence in order to avoid being forced to pay for speeding tickets that they are incorrectly given.

### SUMMARY OF THE INVENTION

It is therefore one of the primary objectives of the claimed invention to provide a method of recording proof of driving speeds and related mobile device in order to allow drivers to defend themselves against incorrect speeding tickets.

According to an exemplary embodiment of the claimed invention, a method of recording proof of driving speeds with a mobile device is disclosed. The method includes receiving position signals indicating a current position of the mobile device, calculating a driving speed at which the mobile device is moving according to the position signals and times at which the position signals were received, and searching a speed camera database and determining when the current position of the mobile device is within a threshold distance of a speed camera listed in the speed camera database. When the current position of the mobile device is within the threshold distance of the speed camera, the method further includes taking a plurality of consecutive pictures using a camera of the mobile device, each picture showing a time stamp indicating the current time, a geographical tag indicating the current position of the mobile device, and a speed stamp indicating the driving speed at which the mobile device is moving, and storing the plurality of consecutive pictures in a storage device.

According to another exemplary embodiment of the claimed invention, a mobile device for recording proof of driving speeds is disclosed. The mobile device includes a position receiving device receiving position signals indicating a current position of the mobile device and calculating a driving speed at which the mobile device is moving according to the position signals and times at which the position signals were received, a processor searching a speed camera database and determining when the current position of the mobile device is within a threshold distance of a speed camera listed in the speed camera database, and a camera taking a plurality of consecutive pictures using a camera of the mobile device, each picture showing a time stamp indicating the current time, a geographical tag indicating the current position of the mobile device, and a speed stamp indicating the driving speed at which the mobile device is moving, wherein the camera takes the plurality of pictures when the current position of the mobile device is within the threshold distance of the speed camera. The mobile device also includes a storage means for storing the plurality of consecutive pictures.

It is an advantage that the present invention allows a driver to obtain proof of his vehicle's driving speed near places where speed cameras are known to be located. Two or more different pictures are taken at different times and locations so that the time and position information may allow the vehicle's driving speed to be calculated. Furthermore, the pictures may be stored in the storage device for future reference to be used as proof in the event that the driver later receives a speeding ticket.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a mobile device in communication with a server and a client device according to the present invention.

FIG. 2 is a detailed functional block diagram of the mobile device in communication with the server according to the present invention.

FIG. 3 is a flowchart illustrating the present invention method of taking pictures with the camera of the mobile device in order to record proof of driving speeds.

### DETAILED DESCRIPTION

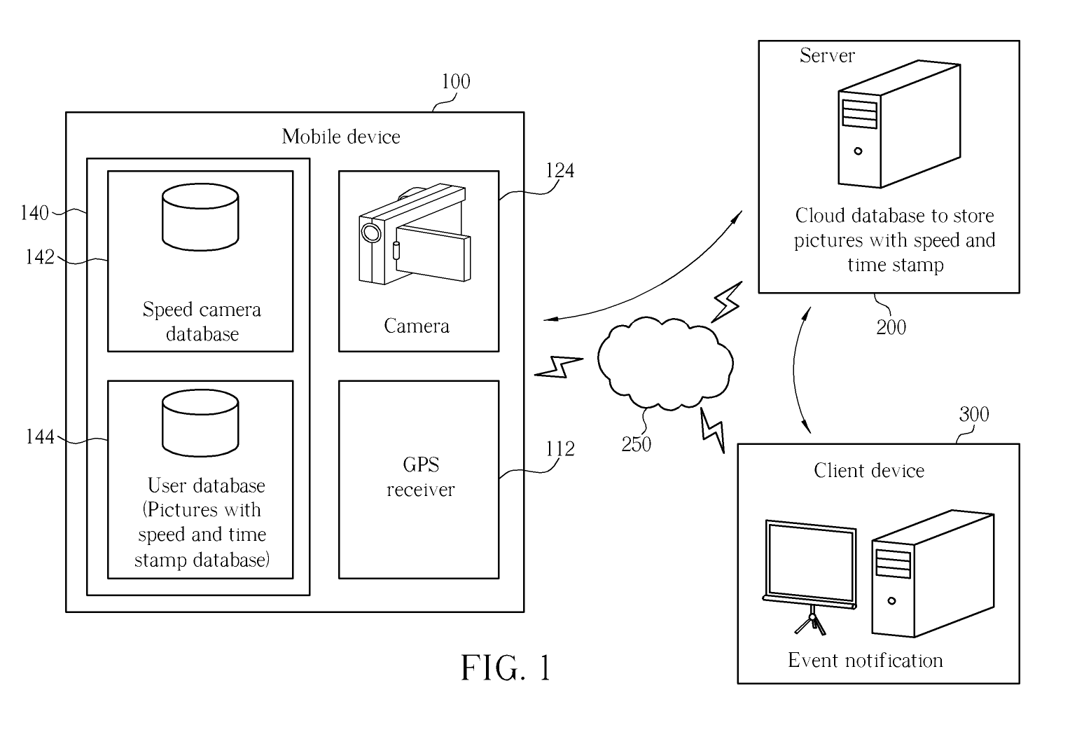

Please refer to FIG. 1. FIG. 1 is a functional block diagram of a mobile device 100 in communication with a server 200 and a client device 300 according to the present invention. The mobile device 100 preferably communicates with the server 200 wirelessly via the Internet 250. Although preferred, the mobile device 100 does not require a wireless internet connection, and can instead connect to the server 200 via a wired connection to a computer.

In the present invention, a user places the mobile device 100 inside a vehicle while the user drives the vehicle. The mobile device 100 contains a storage device 140 having a speed camera database 142 as well as a user database 144. The speed camera database 142 indicates the location of every known speed camera within a selected geographical area. The user database 144 stores pictures taken by the user, as will be explained below.

In short, the mobile device uses a Global Positioning System (GPS) receiver 112 to detect a position of the mobile device 100 and determine a driving speed of a vehicle in which the mobile device 100 is placed. When the mobile device 100 determines that the vehicle is near a speed camera listed in the speed camera database 142, the mobile device 100 warns the user not to speed if it is determined that the driving speed of the vehicle exceeds the local speed limit. Additionally, a camera 124 is activated to take at least two pictures in close succession when a speed camera is detected nearby, and store the pictures in the user database 144. The pictures preferably show an area near the speed camera so as to convey a sense of location as to where the pictures were taken. Furthermore, the pictures show a time stamp indicating the current time, a geographical tag indicating the current position of the mobile device 100, and a speed stamp indicating the driving speed at which the mobile device 100 is moving.

Since the memory capacity of the storage device 140 of the mobile device 100 is limited, the mobile device 100 can transfer pictures to the server 200 so as to store older pictures previously taken by the camera 124 of the mobile device 100 and stored in the user database 144 of the storage device 140. The server 200 may be operated by a company that offers event notifications to subscribing clients, such as the client device 300, regarding driving activities associated with the mobile device 100. For example, the mobile device 100 may be a gift from a parent to a child, with the parent setting up a subscription to receive event notifications on the parent's client device 300 regarding the activity of the mobile device 100. The event notifications can be set up in a variety of ways, including a notification when the mobile device 100 detects a driving speed greater than the local speed limits, when the mobile device 100 is outside a predetermined geographical area, and when the mobile device 100 is being driven around after a curfew time, and so on. Pictures taken by the camera 124 can also be sent to the client device 300 via the server 200.

The server 200 may also be used as a part of fleet management for recording proof of driving speeds for each vehicle in an organization's vehicle fleet. In this implementation, the organization's fleet management would use the server 200 to store pictures taken by each vehicle in the vehicle fleet in order to provide proof of driving speed for each vehicle. In this way, the fleet management using the server 200 could potentially save costs by avoiding paying for incorrectly issued speeding tickets. Similar to the example mentioned in the previous paragraph where a parent could use the client device 300 to set up a subscription to receive event notifications from the server 200 regarding certain driving criteria, the same could be done as part of an organization's fleet management. For example, one or more client devices 300 could be used by people in the organization in order to monitor the driving behavior of drivers in the vehicle fleet. When the server 200 detects certain criteria that prompts a notification to be sent out, the subscribing client devices 300 will receive these event notifications in order to inform those involved with the fleet management.

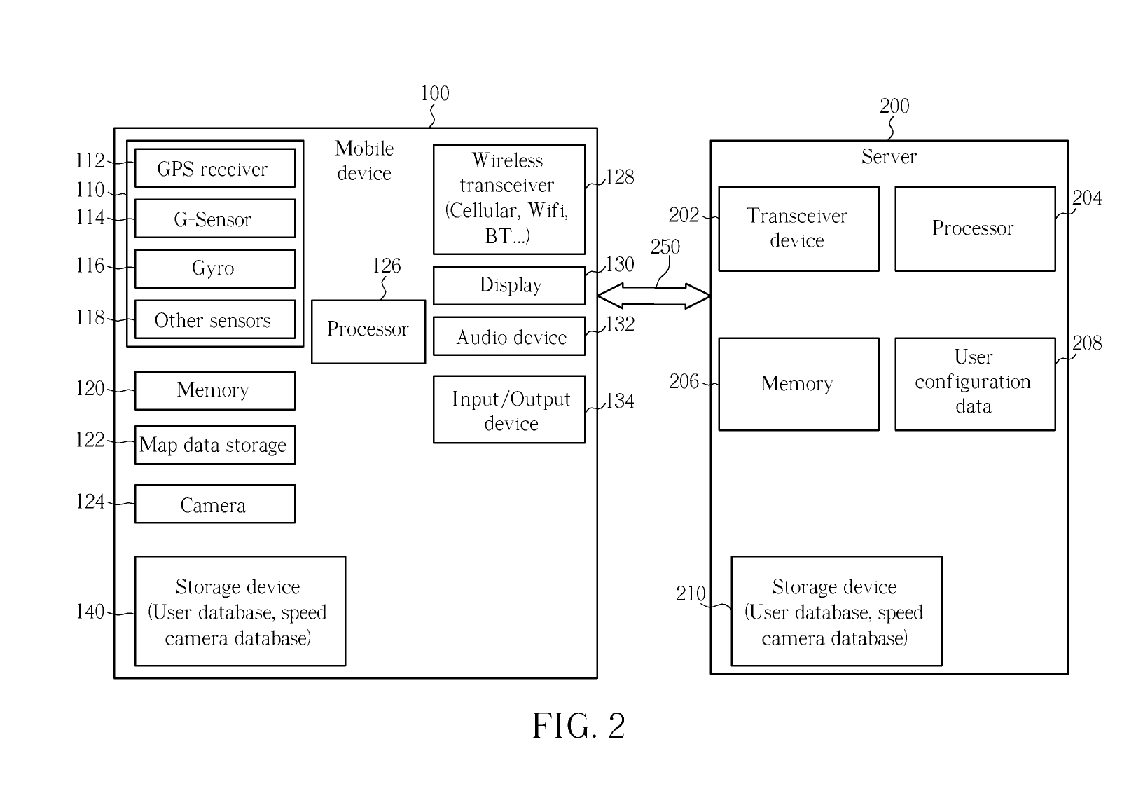

Please refer to FIG. 2. FIG. 2 is a detailed functional block diagram of the mobile device 100 in communication with the server 200 according to the present invention. The mobile device 100 contains a sensor module 110 containing the GPS receiver 112 and optionally containing a g-sensor 114 such as an accelerometer, a gyroscope 116, and other sensors 118. The mobile device 100 also includes a memory 120 for storing program code being executed by a processor 126 and map data storage 122 for storing map data, address data, parking area information, etc. The mobile device 100 further contains a wireless transceiver 128 for communicating wirelessly, such as a cellular transceiver, a WiFi transceiver, or a Bluetooth® transceiver. The wireless transceiver 128 can be used for communicating with the server 200 via the Internet 250 or through a wired internet connection. The mobile device 100 also contains a display 130 for, among other things, letting the user of the mobile device 100 review pictures taken by the camera 124. An audio device 132 can be used for outputting an audible alert when the driving speed measured by the mobile device 100 is greater than the local speed limit, especially when a speed camera is located nearby. The mobile device 100 may also contain any kind of input/output device 134 for interacting with the mobile device 100, such as a keyboard, a touch screen, or an external peripheral device.

The server 200 contains a transceiver device 202 for communicating with the mobile device 100 via the Internet 250. The server 200 also includes a memory 206 for storing program code being executed by a processor 204. The server 200 may store user configuration data 208 containing settings associated with the mobile device 100, such as settings related to how long to store the pictures received from the mobile device 100 in a storage device 210, settings related to when event notifications should be sent to the client device 300, and so on. Besides the storage device 210 being used to store pictures transferred from the mobile device 100, the storage device 210 also stores an up-to-date version of the speed camera database.

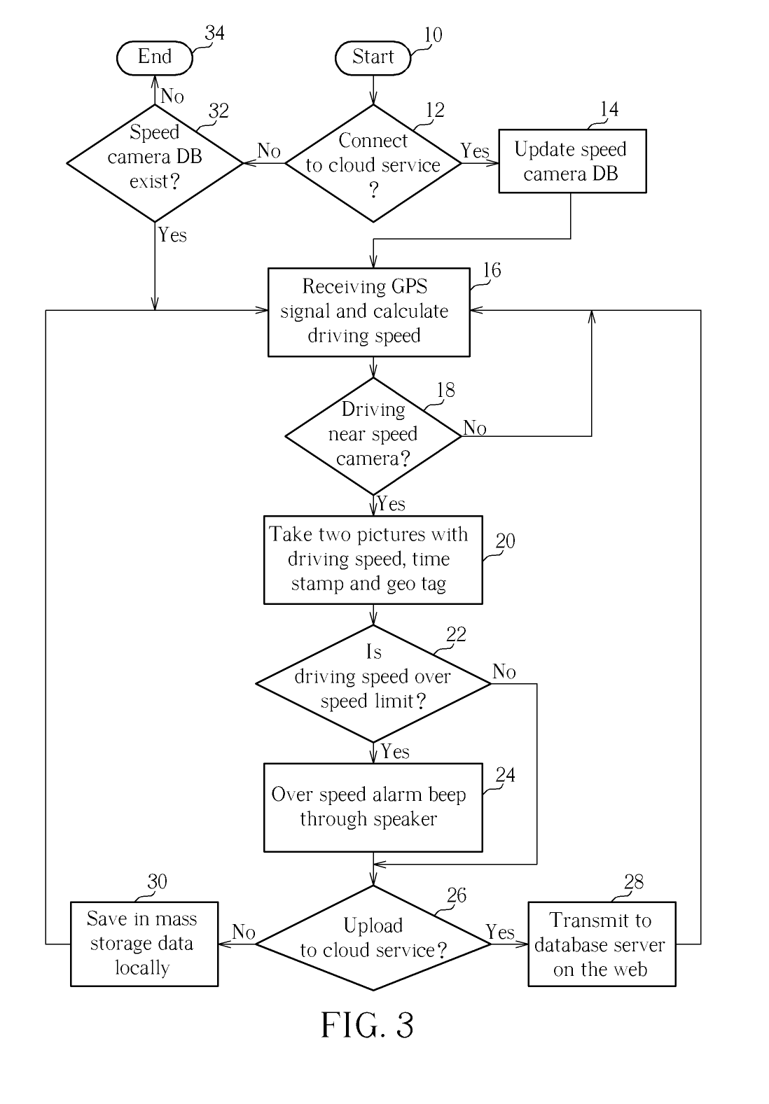

Please refer to FIG. 3. FIG. 3 is a flowchart illustrating the present invention method of taking pictures with the camera 124 of the mobile device 100 in order to record proof of driving speeds. Steps contained in the flowchart will be explained below.

Step 10: Start.

Step 12: Determine if the mobile device 100 is connected to the server 200 or other cloud service via the Internet 250. If so, go to step 14. If not, go to step 32.

Step 14: The mobile device 100 accesses the server 200 and downloads the most recent copy of the speed camera database from the storage device 210 of the server 200 to the speed camera database 142 located in the storage device 140 of the mobile device 100. If the speed camera database 142 in the mobile device 100 is already the most recent version, then this step can be optionally omitted.

Step 16: The GPS receiver 112 receives a plurality of position signals over time, and thereby calculates the vehicle's driving speed according to the change of the position of the mobile device 100 over a period of time.

Step 18: Determine if the vehicle is located near a known speed camera. If so, go to step 20. If not, go back to step 16. In this step, the mobile device 100 consults the speed camera database 142 in order to compare the current position of the mobile device 100 as provided by the GPS receiver 112 to the location of known speed cameras. When the vehicle is located within a threshold distance of a known speed camera, then extra steps must be taken.

Step 20: Take two or more consecutive pictures using the camera 124 of the mobile device 100. Each picture shows a time stamp indicating the current time, a geographical tag indicating the current position of the mobile device as measured by the GPS receiver 112, and a speed stamp indicating the driving speed at which the mobile device is moving.

Step 22: Determine if the driving speed is greater than the local speed limit. If so, go to step 24. If not, go to step 26. The local speed limit can be provided in a database such as the speed camera database 142 or in the map data storage 122.

Step 24: Output an audible alarm through the audio device 132 or another speaker in order to alert the user to the fact that the user is exceeding the local speed limit near a speed camera. Other alarms can also be used instead of audible alarms. For instance, an alert can also be shown on the display 130. Any part of the user interface of the mobile device 100 can be used for outputting the alarm to alert the user that the vehicle is speeding.

Step 26: Determine if the pictures taken in step 20 are to be uploaded to the server 200 or another cloud service via the Internet 250. If so, go to step 28. If not, go to step 30.

Step 28: Since the determination was made in step 12 that the mobile device 100 is connected to the server 200, the pictures are stored in the storage device 210 of the server 200. The process then returns to step 16.

Step 30: Since the determination was made in step 12 that the mobile device 100 is not connected to the server 200, the pictures are stored locally in the user database 144 of the storage device 140 of the mobile device 100. The pictures can also optionally be stored in both the user database 144 of the mobile device 100 and the storage device 210 of the server 200. The process then returns to step 16. The storage device 210 of the server 200 is typically much larger than the storage device 140 of the mobile device 100. Therefore, the storage device 210 of the server 200 may be able to store a year's worth of pictures or more, whereas the storage device 140 of the mobile device 100 may be limited to storing only a few days' worth of pictures.

Step 32: Since no connection was made to the server 200 or other cloud service via the Internet 250, determine if the speed camera 124 exists in the storage device 140 of the mobile device 100. If so, go to step 16. If not, go to step 34.

Step 34: The process ends.

The present invention uses the camera 124 to take two or more consecutive pictures in order to provide proof of the speed of the vehicle in which the mobile device 100 is traveling. There are two forms of proof that can be used. First of all, the driving speed of the vehicle can be calculated directly by the GPS receiver 112, and this information is directly shown on the pictures in the form of the speed stamp indicating the driving speed at which the vehicle is moving. Secondly, the pictures also contain the time stamp indicating the current time and the geographical tag indicating the current position of the vehicle as measured by the GPS receiver 112. By using time and position measurements contained in two different pictures, a difference in the vehicle's position can be calculated and a difference in the time values can be calculated. Then, using the basic equation of rate equals distance divided by time (r=d/t) the vehicle's current speed can be calculated and submitted as proof in the event that the driver of the vehicle received a speeding ticket from a speed camera located near the position where the pictures were taken.

As shown in the flowchart of FIG. 3, the pictures are preferably only taken when the vehicle is near a known speed camera. Therefore, all pictures can be potentially used as proof of the driving speed of the vehicle. If the driver was not speeding but was still given a ticket by way of a speed camera, then the pictures taken near the speed camera can be submitted as evidence of the driver's innocence. Also, the server 200 can also provide pictures to the subscribing client device 300 if the mobile device 100 has been configured with the server in this way.

In the present invention, the mobile device 100 can be a personal navigation device (PND), also known as a GPS device. The mobile device 100 can also be a mobile phone or any other device having the ability to receive position information and take pictures.

In summary, the present invention allows a driver to obtain proof of his vehicle's driving speed near places where speed cameras are known to be located. Two or more different pictures are taken at different times and locations so that the time and position information may allow the vehicle's driving speed to be calculated. The pictures are then stored for future reference to be used as proof in the event that the driver later receives a speeding ticket. In this way, users can avoid having to pay for speeding tickets that were incorrectly issued.

Those skilled in the art will readily observe that numerous modifications and alterations of the device and method may be made while retaining the teachings of the invention. Accordingly, the above disclosure should be construed as limited only by the metes and bounds of the appended claims.

1. A method of recording proof of driving speeds with a mobile device, the method comprising:
receiving position signals indicating a current position of the mobile device;
calculating a driving speed at which the mobile device is moving according to the position signals and times at which the position signals were received;
searching a speed camera database and determining when the current position of the mobile device is within a threshold distance of a speed camera listed in the speed camera database; and
when the current position of the mobile device is determined to be within the threshold distance of the speed camera:
taking a plurality of consecutive pictures using a camera of the mobile device, each picture showing a time stamp indicating the current time, a geographical tag indicating the current position of the mobile device, and a speed stamp indicating the driving speed at which the mobile device is moving; and
storing the plurality of consecutive pictures in a storage device.

2. The method of claim 1, wherein the storage device is located within the mobile device.

3. The method of claim 1, wherein the storage device is located in a server communicating with the mobile device via an Internet connection.

4. The method of claim 3, further comprising the server forwarding the plurality of pictures stored in the storage device of the server to a client device registered with the server.

5. The method of claim 3, further comprising the server transmitting event notifications to a client device registered with the server and subscribed to event notifications.

6. The method of claim 5, wherein the server transmits an event notification to a subscribing client device when the mobile device detects that the driving speed at which the mobile device is moving is greater than a local speed limit.

7. The method of claim 5, wherein the client device is used as part of fleet management or used by a parent for monitoring driving behavior of one or more vehicles using the mobile device.

8. The method of claim 1, wherein the speed camera database is stored within the mobile device.

9. The method of claim 8, wherein the speed camera database is updatable through a server communicating with the mobile device via an Internet connection.

10. The method of claim 1, wherein taking the plurality of consecutive pictures using the camera of the mobile device is only performed when the current position of the mobile device is determined to be within the threshold distance of the speed camera.

11. A mobile device for recording proof of driving speeds, the mobile device comprising:
a position receiving device receiving position signals indicating a current position of the mobile device and calculating a driving speed at which the mobile device is moving according to the position signals and times at which the position signals were received;
a processor searching a speed camera database and determining when the current position of the mobile device is within a threshold distance of a speed camera listed in the speed camera database;
a camera taking a plurality of consecutive pictures using a camera of the mobile device, each picture showing a time stamp indicating the current time, a geographical tag indicating the current position of the mobile device, and a speed stamp indicating the driving speed at which the mobile device is moving, wherein the camera takes the plurality of pictures when the current position of the mobile device is determined to be within the threshold distance of the speed camera; and
a storage means for storing the plurality of consecutive pictures.

12. The mobile device of claim 11, wherein the storage means is a storage device located within the mobile device.

13. The mobile device of claim 11, further comprising a transceiver for establishing an Internet connection, wherein the storage means is a storage device located in a server communicating with the mobile device via the Internet connection.

14. The mobile device of claim 13, wherein the server forwards the plurality of pictures stored in the storage device of the server to a client device registered with the server.

15. The mobile device of claim 13, wherein the server transmits event notifications to a client device registered with the server and subscribed to event notifications.

16. The mobile device of claim 15, wherein the server transmits an event notification to a subscribing client device when the mobile device detects that the driving speed at which the mobile device is moving is greater than a local speed limit.

17. The mobile device of claim 15, wherein the client device is used as part of fleet management or used by a parent for monitoring driving behavior of one or more vehicles using the mobile device.

18. The mobile device of claim 11, wherein the speed camera database is stored within the mobile device.

19. The mobile device of claim 18, further comprising a transceiver for establishing an Internet connection, wherein the speed camera database is updatable through a server communicating with the mobile device via the Internet connection.

20. The mobile device of claim 11, wherein taking the plurality of consecutive pictures using the camera of the mobile device is only performed when the current position of the mobile device is determined to be within the threshold distance of the speed camera.
